(19) United States
(12) Patent Application Publication
(10) Pub. No.: US 2017/0264500 A1
(43) Pub. Date: Sep. 14, 2017

(54) NUMBER-OF-SCALES ESTIMATION APPARATUS, NUMBER-OF-SCALES MANAGEMENT SYSTEM, NUMBER-OF-SCALES ESTIMATION METHOD, NUMBER-OF-SCALES MANAGEMENT METHOD, AND STORAGE MEDIUM

(71) Applicant: NEC CORPORATION, Tokyo (JP)

(72) Inventor: Seiichi KOIZUMI, Tokyo (JP)

(73) Assignee: NEC CORPORATION, Tokyo (JP)

(21) Appl. No.: 15/509,620

(22) PCT Filed: Sep. 3, 2015
(86) PCT No.: PCT/JP2015/004477

§ 371 Date: Mar. 8, 2017

(30) Foreign Application Priority Data
Sep. 9, 2014 (JP) 2014-182814

(51) Int. Cl. H04L 12/24

(52) U.S. Cl. CPC H04L 41/145

(57) ABSTRACT

A number-of-scales estimation apparatus includes a function rule quantification unit, a service amount calculation unit, a capability model generation unit and a number-of-scales estimation unit. The function rule quantification unit calculates a quantification value of a function rule established in a node providing a network function. The service amount calculation unit calculates a service amount per unit time of node instances in the node. The capability model generation unit generates, on the basis of the function rule quantification value and service amount, a capability model representative of a relationship among an amount of input traffic to the node, the function rule quantification value and the number of scales for the node instances. The number-of-scales estimation unit uses the capability model to estimate a number of scales in accordance with the amount of input traffic and function rule quantification value.

### TECHNICAL FIELD

The present invention relates to a technique for managing the number of scales of a node providing a network function.

### BACKGROUND ART

Recently, various IT (information technology) services are provided to terminals such as mobile phones and computers via networks. Examples of IT services include web servers, motion picture distribution, and business systems. For providing such IT services, various network functions such as elimination of unnecessary traffics and IP (Internet Protocol) address conversion is required. Thus, IT service providers use network function providing apparatuses including various nodes for providing network functions. The nodes of the network function providing apparatuses include LB (load balancer), FW (firewall), NAT (network address translation), and the like.

Use traffic amounts of the IT services always fluctuate due to a plurality of factors such as the number of users and time slots. However, it is difficult for conventional network control techniques to control throughput performances of the network function providing apparatuses and nodes thereof. Thus, the IT service providers are required to adjust traffic amounts to be processed by the network function providing apparatuses according to the throughput performances of the network function providing apparatuses.

As technologies for dealing with the above problems, there are network function virtualization technologies such as NFV (Network Function Virtualization) and SDN (Software Defined Networking). The network function virtualization technology realizes nodes such as FW and LB by software. Further, control to increase (scale-out) or decrease (scale-in) a parallel number of virtualized node instances in the node can be performed for each node. Accordingly, the throughput performance of the network function can be controlled. For example, in the case of the NFV, an individual network function is provided by a node referred to as a VNF (virtualized network function). Further, a plurality of node instances referred to as VNFC (VNF components) operate in the VNF node. In this case, scaling of the VNFC enables control of a capability of processing. The VNFCs are individually different virtual machines. The VNFC adjusts the network function since a function rule for providing a function according to a network requirement is set thereto. For example, in the case of the VNFC providing a firewall function, function rules as illustrated in FIG. 18 are set. The VNFC to which such function rules are set can provide functions of permitting accesses of HTTP (Hypertext Transfer Protocol) and FTP (File Transfer Protocol) and avoiding an attack.

PTL 1 describes an example of the related art for managing a performance of a network function providing apparatus using the network function virtualization technology. According to the related art, when performances of agents (corresponding to the above-described node instances) providing various network functions do not fulfill target values, resources (for example, a CPU (central processing unit) and a RAM (random access memory) and the like) are reassigned to each agent.

### CITATION LIST

### Patent Literature

PTL 1: Japanese Patent Application Laid-open Publication No. 2012-74056

### SUMMARY OF INVENTION

### Technical Problem

However, the related art described in PTL 1 has following problems.

The capability of processing the node instances such as the above-described VNFC is affected by a setting content of the function rule of the node. For example, as the setting contents of the function rule to be set are more, the node instance consumes more resources such as the CPU and takes a longer time to perform processing. Thus, the capability of processing the node instances changes according to the setting contents of the function rule. In this regard, in order to estimate the number of parallel processing (the number of scales) required for each node according to an assumed input traffic, it is necessary to estimate the capability of processing the node instances more precisely. However, there is no description in PTL 1 of estimating the capability of processing the agent and further estimating the number of parallel processing (the number of scales) of the agent. Thus, the related art may not sufficiently control the performance of the agent by only reassigning the resources when the performance does not fulfill the target value.

The present invention is intended to solve the above-described problems. More specifically, an object of the present invention is to provide a technique for more precisely estimating a capability of processing instances in a node providing a network function and more precisely estimating the number of scales that can deal with an input traffic.

### Solution to Problem

To achieve the object, a number-of-scales estimation apparatus according to the present invention includes:

function rule quantification means for calculating a function rule quantification value obtained by quantifying a function rule based on a setting history of the function rule set to a node providing a network function;

service amount calculation means for calculating a service amount per unit time of a node instance operating in the node based on a service history of the node;

capability model generation means for generating a capability model representative of a relationship among an amount of input traffic to the node, the function rule quantification value, and a number of the node instances (a number of scales) based on a pair of the function rule quantification value and the service amount acquired for the node; and

number-of-scales estimation means for using the capability model to estimate the number of scales in accordance with the amount of input traffic to be assumed and the function rule quantification value.

Further, a number-of-scales management system according to the present invention includes:

a network function providing apparatus including a node providing a network function;

an acquisition apparatus configured to acquire a setting history of a function rule (a function rule setting history) set to the node and a service history of the node from the network function providing apparatus;

the number-of-scales estimation apparatus as described above configured to use the function rule setting history and the service history acquired by the acquisition apparatus and estimate a number of scales of the node in the network function providing apparatus; and

a control apparatus configured to control the number of scales of the node in the network function providing apparatus based on the number of scales estimated by the number-of-scales estimation apparatus.

Further, a number-of-scales estimation method according to the present invention includes:

calculating a function rule quantification value obtained by quantifying a function rule based on a setting history of the function rule set to a node providing a network function;

calculating a service amount per unit time of a node instance operating in the node based on a service history of the node;

generating a capability model representative of a relationship among an amount of input traffic to the node, the function rule quantification value, and a number of the node instances (a number of scales) based on a pair of the function rule quantification value and the service amount acquired for the node; and

using the capability model to estimate the number of scales in accordance with the amount of input traffic to be assumed and the function rule quantification value.

Further, a number-of-scales management method according to the present invention includes:

acquiring a setting history of a function rule (a function rule setting history) set in a node in a network function providing apparatus including the node providing a network function;

acquiring a service history of the node in the network function providing apparatus;

estimating a number of scales of the node in the network function providing apparatus using the number-of-scales estimation method according to claim 8 based on the acquired function rule setting history and the service history; and

controlling the number of scales of the node in the network function providing apparatus based on the estimated number of scales.

Further, a storage medium according to the present invention storing a computer program that causes a computer to execute:

a function rule quantification step of calculating a function rule quantification value obtained by quantifying a function rule based on a setting history of the function rule set to a node providing a network function;

a service amount calculation step of calculating a service amount per unit time of a node instance operating in the node based on a service history of the node;

a capability model generation step of generating a capability model representative of a relationship among an amount of input traffic to the node, the function rule quantification value, and a number of the node instances (a number of scales) based on a pair of the function rule quantification value and the service amount acquired for the node; and

a number-of-scales estimation step of using the capability model to estimate the number of scales in accordance with the amount of input traffic to be assumed and the function rule quantification value.

### Advantageous Effects of Invention

The present invention can provide a technique for more precisely estimating a capability of processing instances in a node providing a network function and more precisely estimating the number of scales that can deal with an input traffic.

### BRIEF DESCRIPTION OF DRAWINGS

FIG. 1 is a block diagram illustrating a configuration of a number-of-scales management system as a first example embodiment of the present invention.

FIG. 2 illustrates a hardware configuration of the number-of-scales management system as the first example embodiment of the present invention.

FIG. 3 is a flowchart illustrating a history acquisition operation of the number-of-scales management system as the first example embodiment of the present invention.

FIG. 4 is a flowchart illustrating a capability model generation operation of the number-of-scales management system as the first example embodiment of the present invention.

FIG. 5 is a flowchart illustrating a number-of-scales estimation operation of the number-of-scales management system as the first example embodiment of the present invention.

FIG. 6 is a flowchart illustrating a number-of-scales control operation of the number-of-scales management system as the first example embodiment of the present invention.

FIG. 7 is a block diagram illustrating a configuration of a number-of-scales management system as a second example embodiment of the present invention.

FIG. 8 is a flowchart illustrating a capability model generation operation of the number-of-scales management system as the second example embodiment of the present invention.

FIG. 9 is a flowchart illustrating a chain instance information generation operation of the number-of-scales management system as the second example embodiment of the present invention.

FIG. 10 is a flowchart illustrating a number-of-scales control operation of the number-of-scales management system as the second example embodiment of the present invention.

FIG. 11 illustrates an example of a function rule setting history according to the second example embodiment of the present invention.

FIG. 12 illustrates an example of a service history according to the second example embodiment of the present invention.

FIG. 13 illustrates an example of function rule quantification value information according to the second example embodiment of the present invention.

FIG. 14 illustrates an example of a capability model according to the second example embodiment of the present invention.

FIG. 15 illustrates an example of service chain definition information according to the second example embodiment of the present invention.

FIG. 16 illustrates an example of input traffic information according to the second example embodiment of the present invention.

FIG. 17 illustrates an example of chain instance information according to the second example embodiment of the present invention.

FIG. 18 illustrates an example of function rules set to a node of the related art.

### DESCRIPTION OF EMBODIMENTS

Example embodiments of the present invention will be described in detail below with reference to the attached drawings.

### First Example Embodiment

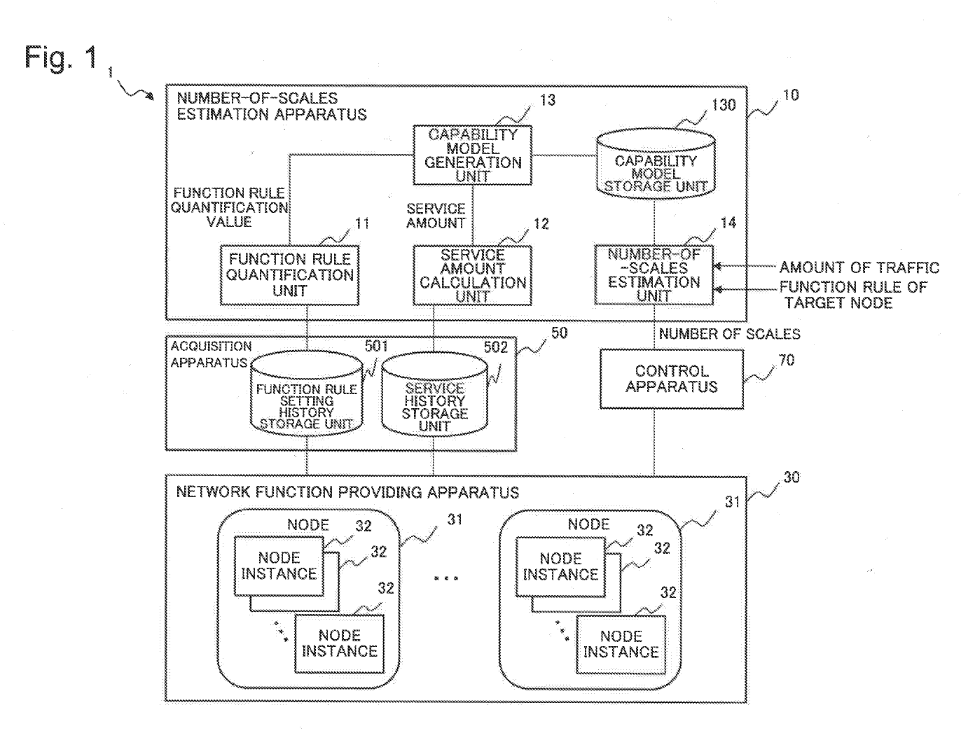

FIG. 1 illustrates a configuration of a number-of-scales management system 1 as a first example embodiment of the present invention. In FIG. 1, the number-of-scales management system 1 includes a number-of-scales estimation apparatus 10, a network function providing apparatus 30, an acquisition apparatus 50, and a control apparatus 70. The number-of-scales estimation apparatus 10 is communicably connected to each of the acquisition apparatus 50 and the control apparatus 70. The network function providing apparatus 30 is communicably connected to each of the acquisition apparatus 50 and the control apparatus 70. The number-of-scales estimation apparatus 10 includes a function rule quantification unit 11, a service amount calculation unit 12, a capability model generation unit 13, a capability model storage unit 130, and a number-of-scales estimation unit 14. The capability model storage unit 130 configures an example embodiment of a part of the capability model generation unit of the present invention. The network function providing apparatus 30 includes one or more nodes 31. One or more node instances 32 operates in each of the nodes 31. The acquisition apparatus 50 includes a function rule setting history storage unit 501 and a service history storage unit 502.

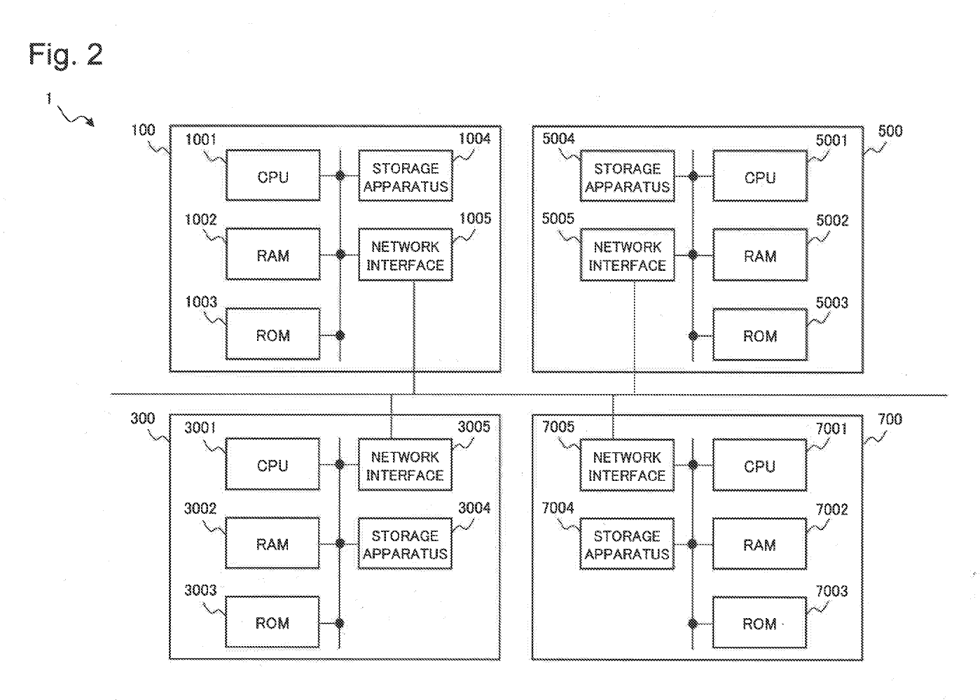

The number-of-scales estimation apparatus 10, the network function providing apparatus 30, the acquisition apparatus 50, and the control apparatus 70 may be respectively configured by hardware elements as illustrated in FIG. 2. Specifically, the number-of-scales estimation apparatus 10 can be configured by a computer apparatus 100. The computer apparatus 100 includes a CPU (central processing unit) 1001, a RAM (random access memory) 1002, a ROM (read only memory) 1003, a storage apparatus 1004 such as a hard disk, and a network interface 1005. The network function providing apparatus 30 can be configured by a computer apparatus 300. The computer apparatus 300 includes a CPU 3001, a RAM 3002, a ROM 3003, a storage apparatus 3004 such as a hard disk, and a network interface 3005. The acquisition apparatus 50 can be configured by a computer apparatus 500. The computer apparatus 500 includes a CPU 5001, a RAM 5002, a ROM 5003, a storage apparatus 5004 such as a hard disk, and a network interface 5005. The control apparatus 70 can be configured by a computer apparatus 700. The computer apparatus 700 includes a CPU 7001, a RAM 7002, a ROM 7003, a storage apparatus 7004 such as a hard disk, and a network interface 7005. In this case, respective the number-of-scales estimation apparatus 10, the acquisition apparatus 50, and the control apparatus 70 are communicably connected via the network interfaces 1005, 5005, and 7005. Further, respective network function providing apparatus 30, the acquisition apparatus 50, and the control apparatus 70 are communicably connected via the network interfaces 3005, 5005, and 7005. The network function providing apparatus 30 includes unillustrated network interface for connecting the apparatus to a service side or a terminal side to be provided with the network function in addition to the network interface 3005.

When the number-of-scales management system 1 is configured by the hardware elements as in FIG. 2, each function block of the function rule quantification unit 11, the service amount calculation unit 12, and the number-of-scales estimation unit 14 is configured as follows. More specifically, each of the function blocks is configured by the network interface 1005 and the CPU 1001 reading and executing a computer program and various pieces of data stored in the ROM 1003 and the storage apparatus 1004 in the RAM 1002. The capability model generation unit 13 is configured by the CPU 1001 reading and executing a computer program and various pieces of data stored in the ROM 1003 and the storage apparatus 1004 in the RAM 1002. The node 31 and the node instance 32 are configured by the CPU 3001 reading and executing a computer program and various pieces of data stored in the ROM 3003 and the storage apparatus 3004 in the RAM 3002. The function rule setting history storage unit 501 and the service history storage unit 502 of the acquisition apparatus 50 are configured by the storage apparatus 5004. The hardware configurations of each apparatus and each function block thereof are not limited to the above-described configuration. For example, each apparatus may be partially or entirely realized on the same computer apparatus. As a specific example, the number-of-scales estimation apparatus 10 and the acquisition apparatus 50 may be realized on the same computer apparatus, and the network function providing apparatus 30 and the control apparatus 70 may be realized on the same computer apparatus. In this case, the apparatuses which require transmission and reception of information therebetween may be connected by inputting and outputting information via the storage apparatus instead of being connected via the network interface.

Next, the function blocks of each apparatus are described.

The node 31 of the network function providing apparatus 30 provides a network function based on a set function rule.

The node instances 32 are instances of the node 31 and each of the node instances is realized as a virtual machine. The node instance 32 in operation executes processing (a service) for providing the network function in response to a request from an outside.

The acquisition apparatus 50 acquires a function rule setting history of each node 31 and a service history of each node 31 from the network function providing apparatus 30. The acquisition apparatus 50 stores the acquired function rule setting history in the function rule setting history storage unit 501. Further, the acquisition apparatus 50 stores the acquired service history in the service history storage unit 502.

The function rule setting history represents a setting history of the function rule set to the node 31. For example, the function rule setting history may be a history of setting information including a setting content of the function rule set to the node 31 and a set time thereof. The acquisition apparatus 50 further acquires the function rule setting history when the function rule is set to a new node 31 and when the function rule is changed in the existing node 31 in the network function providing apparatus 30. The acquisition apparatus 50 adds and stores the newly acquired function rule setting history to the function rule setting history storage unit 501.

Further, for example, the service history may be information including a pair of a service time required for processing executed by the node instance 32 of each node 31 and a processed data amount. When the node instance 32 newly executes processing in the network function providing apparatus 30, the acquisition apparatus 50 further acquires, adds, and stores the service history thereof to the service history storage unit 502.

The function rule quantification unit 11 of the number-of-scales estimation apparatus 10 calculates a function rule quantification value obtained by quantifying the function rule based on the function rule setting history of the node 31. The function rule quantification value is information which can quantitatively express the setting content of the function rule. Specifically, the number-of-scales estimation apparatus 10 acquires the function rule setting history from the function rule setting history storage unit 501 of the acquisition apparatus 50. Subsequently, the function rule quantification unit 11 calculates the function rule quantification value for each setting information of the function rule regarding each node 31. If there is a plurality of pieces of setting information regarding the same node 31, the function rule quantification unit 11 calculates a plurality of function rule quantification values regarding the same node 31.

The service amount calculation unit 12 calculates a service amount per unit time of the node instance 32 based on the service history of the node 31. Specifically, the service amount calculation unit 12 acquires the service history from the acquisition apparatus 50. For example, the service amount calculation unit 12 can calculate the service amount per unit time based on the service time and the data amount included in the service history.

The service amount calculation unit 12 associates the service amount calculated for each node 31 with the function rule quantification value of the node 31 and stores the associated service amount and quantification value in the storage apparatus 1004. If a plurality of function rule quantification values are calculated for one node 31, the service amount calculation unit 12 may calculate the above-described service amount for each of the function rule quantification values based on the service history in a period in which the function rule quantification value is valid. The service amount calculation unit 12 associates the calculated service amount with the relevant function rule quantification value. The valid period of the function rule quantification value can be calculated from a set time of the function rule included in the function rule setting history.

The capability model generation unit 13 generates a capability model representative of a relationship among an amount of input traffic to the node 31, the function rule quantification value, and the number of the node instances 32 (the number of scales) based on a pair of the function rule quantification value and the service amount acquired for each node 31. In other words, the capability model includes a calculation formula which can calculate the number of the node instances 32 according to the function rule quantification value and the amount of input traffic of the node 31. The capability model generation unit 13 stores the capability model generated for each node 31 in the capability model storage unit 130.

The number-of-scales estimation unit 14 estimates the number of scales using the capability model of the node 31 based on the amount of input traffic assumed to the node 31 and the function rule quantification value. The number-of-scales estimation unit 14 outputs information representing the number of scales estimated for each node 31 to the control apparatus 70.

The control apparatus 70 controls the number of the node instances 32 in the node 31 of the network function providing apparatus 30 based on the number of scales of each node 31 output from the number-of-scales estimation apparatus 10.

Operations of the number-of-scales management system 1 as configured above are described with reference to the attached drawings.

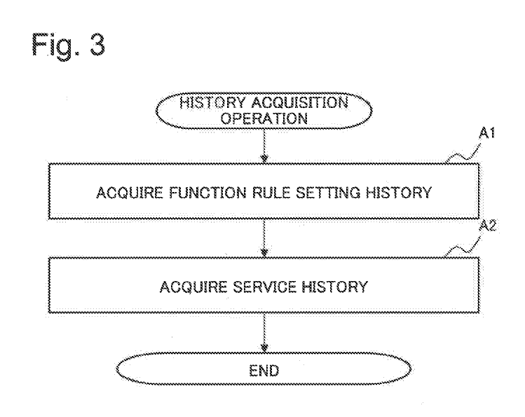

First, a history acquisition operation by the acquisition apparatus 50 is illustrated in FIG. 3.

In FIG. 3, first, the acquisition apparatus 50 acquires the function rule setting history of the node 31 from the network function providing apparatus 30 (step A1). As described above, the acquisition apparatus 50 stores the acquired function rule setting history in the function rule setting history storage unit 501.

Further, the service amount calculation unit 12 acquires the service history of the node 31 from the network function providing apparatus 30 (step A2). As described above, the acquisition apparatus 50 stores the acquired service history in the service history storage unit 502.

The operations of step A1 and step A2 do not need to be executed in this order. The operations of step A1 and step A2 may be executed approximately at the same time. Further, the operations of step A1 and step A2 may be repeatedly executed during a specified period.

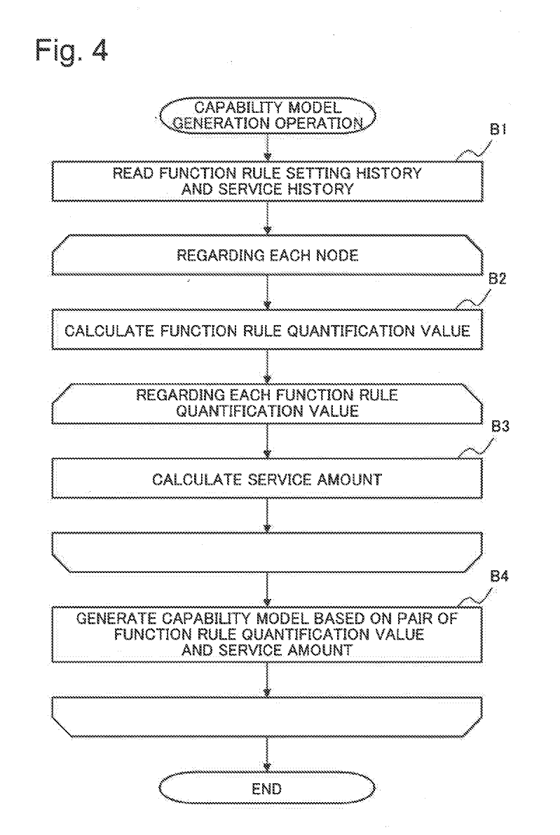

Next, a service model generation operation by the number-of-scales estimation apparatus 10 is illustrated in FIG. 4.

In FIG. 4, first, the function rule quantification unit 11 reads the function rule setting history and the service history from the function rule setting history storage unit 501 and the service history storage unit 502 of the acquisition apparatus 50 (step B1).

Next, the function rule quantification unit 11 repeats following steps B2 to B4 for each node 31 stored in the function rule setting history.

First, the function rule quantification unit 11 calculates the function rule quantification value from the function rule setting history regarding the node 31 (step B2).

As described above, the function rule quantification unit 11 may calculate the function rule quantification value for each setting information regarding the node 31.

Next, the service amount calculation unit 12 calculates the service amount per unit time of the node instance 32 operating on the node 31 with respect to each function rule quantification value of the node 31 calculated in step B2 (step B3).

Specifically, the service amount calculation unit 12 may use the service history of the node 31 in the valid period of each function rule quantification value and calculate the corresponding service amount. Further, the service amount calculation unit 12 may calculate the service amount based on the data amount and the service time of each processing included in the relevant service history. Subsequently, the service amount calculation unit 12 associates each function rule quantification value with the corresponding service amount.

Next, the capability model generation unit 13 generates the capability model representative of the relationship among the amount of input traffic to the node 31, the function rule quantification value, and the number of scales based on a set of pairs of the function rule quantification value and the service amount acquired for the node 31 (step B4). Subsequently, the capability model generation unit 13 stores the capability model generated for the node 31 in the capability model storage unit 130.

When execution of steps B2 to B4 is completed for each node 31, the number-of-scales estimation apparatus 10 terminates the service model generation operation.

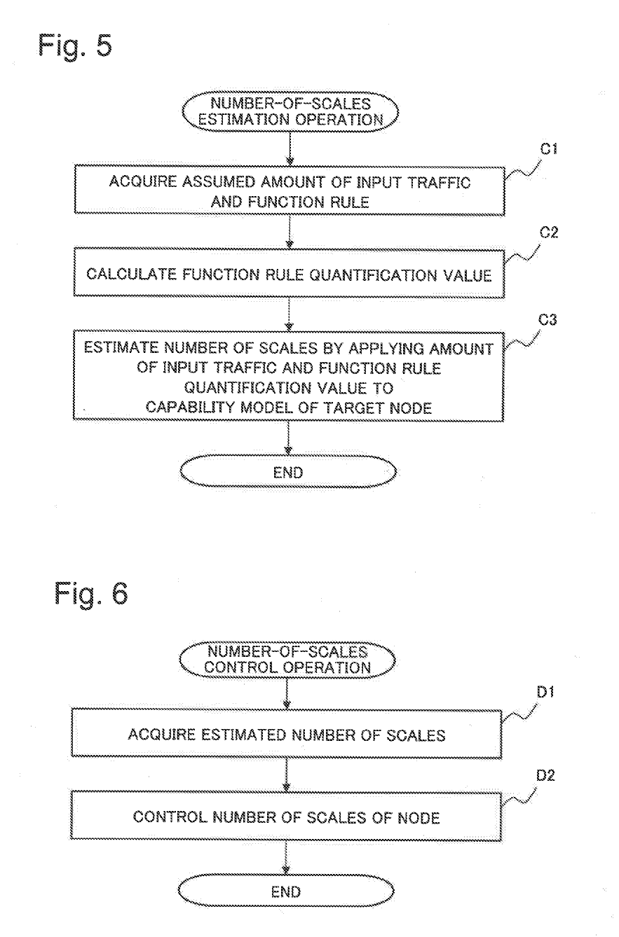

Next, a number-of-scales estimation operation by the number-of-scales estimation apparatus 10 is illustrated in FIG. 5. In FIG. 5, it is assumed that the node 31 to be a target for estimating the number of scales is specified.

In FIG. 5, first, the number-of-scales estimation unit 14 acquires the amount of input traffic assumed to the node 31 as the estimation target and a content of the function rule set to the node 31 (step C1). For example, the number-of-scales estimation unit 14 may acquire the amount of input traffic assumed to the node 31 as the estimation target and the content of the function rule from an input apparatus (not illustrated), the network interface 1005, the storage apparatus 1004, or the like.

Next, the function rule quantification unit 11 calculates the function rule quantification value based on the function rule acquired in step C1 (step C2).

Next, the number-of-scales estimation unit 14 acquires the capability model of the node 31 from the capability model storage unit 130. The number-of-scales estimation unit 14 applies the amount of input traffic acquired in step C1 and the function rule quantification value calculated in step C2 to the capability model of the node 31. Accordingly, the number-of-scales estimation unit 14 calculates and outputs the number of scales of the node 31 to the control apparatus 70 (step C3).

Next, a number-of-scales control operation of the control apparatus 70 is illustrated in FIG. 6.

In FIG. 6, first, the control apparatus 70 acquires the number of scales output from the number-of-scales estimation apparatus 10 (step D1).

Next, the control apparatus 70 controls the number of node instances 32 in the node 31 on the network function providing apparatus 30 based on the acquired number of scales (step D2). For example, when the number of node instances 32 operating with respect to the node 31 is different from the estimated number of scales, the control apparatus 70 changes the number of the node instances 32 to match with the estimated number of scales. Further, when the node 31 does not operate yet, the node instances 32 of the node 31 are generated by the estimated number of scales, and the node 31 is operated.

Thus, the control apparatus 70 terminates the number-of-scales control operation. The number-of-scales management system 1 may repeat the operations of the above-described steps C1 to C3, D1 and D2 with respect to each node 31 in operated or to be operated in the network function providing apparatus 30.

Next, an effect of the first example embodiment of the present invention is described.

The number-of-scales management system as the first example embodiment of the present invention can more precisely estimate the capability of processing the instances in the node providing the network function and more precisely control the number of scales that can deal with the input traffic.

The reason of the effect is described. In the present example embodiment, the acquisition apparatus acquires the function rule setting history and the service history set to each node of the network function providing apparatus. The function rule quantification unit of the number-of-scales estimation apparatus calculates the function rule quantification value based on the function rule setting history. The service amount calculation unit calculates the service amount per unit time of the node instance of each node based on the service history. The capability model generation unit generates the capability model representative of the relationship among the amount of input traffic, the function rule quantification value, and the number of scales based on the pair of the function rule quantification value and the service amount. The number-of-scales estimation unit estimates the number of node instances corresponding to the assumed amount of input traffic using the capability model. Subsequently, the control apparatus controls the number of node instances based on the estimated number of scales, and thus the effect of the first example embodiment is acquired.

Therefore, the present example embodiment can improve estimation precision of the capability of processing the instances in the node. Accordingly, the present example embodiment can more precisely estimate the number of scales which can process the assumed input traffic by necessary minimum resources in response to the content of the function rule set to the nodes and a change thereof.

### Second Example Embodiment

Next, a second example embodiment of the present invention will be described in detail with reference to the attached drawings. In the present example embodiment, an example is described in which a service chain execution apparatus is applied to the network function providing apparatus of the present invention. The service chain execution apparatus is an apparatus for executing a service chain that connects a plurality of nodes and causes the connected nodes to function. The same configurations and the steps of the similar operations as those in the first example embodiment of the present invention are denoted by the same reference numerals in each drawing referred to in the description of the present example embodiment, and the detailed descriptions thereof are omitted in the present example embodiment.

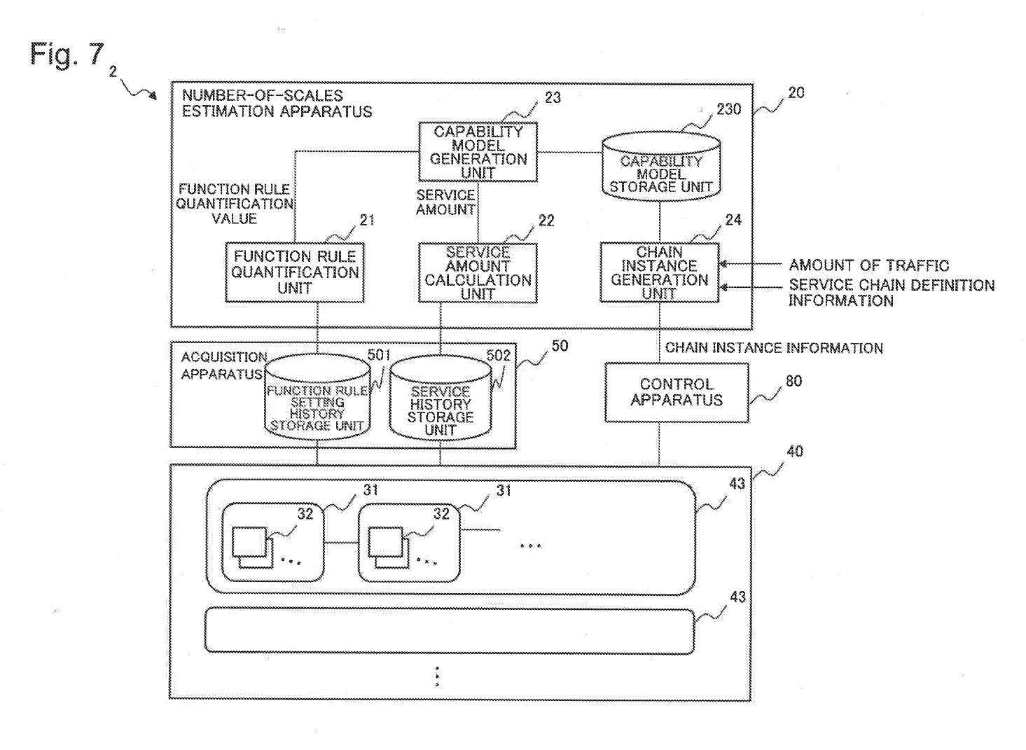

First, a configuration of a number-of-scales management system 2 as the second example embodiment of the present invention is illustrated in FIG. 7. In FIG. 7, the number-of-scales management system 2 includes a number-of-scales estimation apparatus 20, a service chain execution apparatus 40, the acquisition apparatus 50, and a control apparatus 80. The service chain execution apparatus 40 configures an example embodiment of the network function providing apparatus of the present invention. As with the first example embodiment of the present invention, the number-of-scales estimation apparatus 20 and the service chain execution apparatus 40 are each communicably connected to the acquisition apparatus 50 and the control apparatus 80. The number-of-scales estimation apparatus 20 includes a function rule quantification unit 21, a service amount calculation unit 22, a capability model generation unit 23, a capability model storage unit 230, and a chain instance generation unit 24. The capability model storage unit 230 configures an example embodiment of the capability model generation unit of the present invention. The chain instance generation unit 24 configures an example embodiment of the number-of-scales estimation unit of the present invention. The service chain execution apparatus 40 includes a service chain 43, the nodes 31, and the node instances 32. Each apparatus and each function block thereof configuring the number-of-scales management system 2 can be respectively configured by the hardware elements illustrated in FIG. 2 as with the first example embodiment of the present invention. The hardware configurations of each apparatus and each function block thereof are not limited to the above-described configuration.

Next, the function blocks of each apparatus are described.

The service chain execution apparatus 40 is an apparatus for executing the service chain 43 that connects a plurality of the nodes 31 and causes the connected nodes to function. The service chain 43 provides, to an apparatus which provides various IT services to a terminal, a series of the network functions corresponding to contents of the IT services by cooperating the network functions. For example, the service chain 43 for providing the network function necessary for providing a web service to a terminal; the service chain 43 necessary for providing a motion picture distribution system or the like may exist.

The service chain 43 is defined by definition information. For example, the definition information of the service chain 43 may be information including each node 31 to be connected and the function rule set to each node 31.

Further, the service chain 43 is configured to operate by generation of an instance (a chain instance) of the service chain 43 based on the definition information of the service chain 43. The operating service chain 43 provides a series of the network functions by sequentially processing the input traffics to flow in by the node instance 32 of each node 31. In the service chain execution apparatus 40, one or more service chains 43 can operate.

The acquisition apparatus 50 is configured similarly to the first example embodiment of the present invention. Accordingly, the acquisition apparatus 50 acquires the function rule setting history and the service history of each node 31 configuring the service chain 43 from the service chain execution apparatus 40.

In the present example embodiment, the function rule setting history includes a node ID for identifying the node 31, information representing the content of the function rule, and information (time stamp) representing a time when the setting of the function rule becomes valid. Further, the service history includes the node ID, a start time and an end time of processing, and the processed data amount. The acquisition apparatus 50 respectively stores the function rule setting history and the service history in the function rule setting history storage unit 501 and the service history storage unit 502.

The function rule quantification unit 21 of the number-of-scales estimation apparatus 20 refers to the function rule setting history acquired from the service chain execution apparatus 40 to calculate the function rule quantification value based on the number of function rules. For example, the function rule quantification value may be the number of function rules itself. The function rule quantification unit 21 associates the calculated function rule quantification value with the node ID and the time stamp thereof.

The service amount calculation unit 22 refers to the service history acquired from the service chain execution apparatus 40 and calculates the service amount for each valid period of the function rule quantification value with respect to each node 31. Further, the service amount calculation unit 22 associates the service amount calculated for each valid period with the function rule quantification value of the valid period and the relevant node ID.

As described above, the service history includes the node ID, the start time and the end time of the processing, and the processed data amount. Further, the node ID, the function rule quantification value, and the time stamp are associated by the function rule quantification unit 21. Thus, the service amount calculation unit 22 first calculates the valid period for each function rule quantification values calculated with respect to the nodes 31 of the same node ID. Specifically, the service amount calculation unit 22 may regard, with respect to a certain function rule quantification value of a certain node ID, a period from the time stamp thereof to a next latest time stamp from among the time stamps of another function rule quantification value of the same node ID as the valid period.

The service amount calculation unit 22 may calculate the service amount by dividing an average value of the data amount by an average value of the service time from the start time to the end time with respect to the service history of the valid period including the relevant node ID for each valid period of the function rule quantification value. The service history of the valid period may be the service history that both or either one of the start time and the end time is included in the valid period. The service amount calculation unit 22 associates the node ID, the function rule quantification value, and the service amount.

For example, it is assumed that a function rule quantification value r1 and a function rule quantification value r2 are calculated for a certain node 31. Further, it is assumed that the function rule quantification value r1 is associated with a time stamp t1, and the function rule quantification value r2 is associated with a time stamp t2. However, it is assumed that the time stamp t2 is newer than the time stamp t1. In this case, the service amount calculation unit 22 calculates a period from the time stamps t1 to t2 as a valid period of the function rule quantification value r1. Further, it is assumed that there is no function rule quantification value associated with a time stamp newer than the time stamp t2 in the same node 31. In this case, the service amount calculation unit 22 calculates a period from the time stamp t2 to a present time as a valid period of the function rule quantification value r2. The present time mentioned here may be, for example, a time point at which processing for calculating the valid period is performed or may be up to the latest time point at which the service history is acquired.

In this case, the service amount calculation unit 22 calculates a service amount s1 with respect to the node 31 based on the service history from the time stamps t1 to t2 and associates the service amount s1 with the node ID and the function rule quantification value r1. Further, the service amount calculation unit 22 calculates a service amount s2 with respect to the same node 31 based on the service history from the time stamp t2 to the present time and associates the service amount s2 with the node ID and the function rule quantification value r2.

The capability model generation unit 23 generates a service amount estimation equation and an equation representative of the relationship among the service amount, the amount of input traffic, and the number of scales as the capability model.

Specifically, the capability model generation unit 23 performs statistical analysis having the service amount as an objective variable and the function rule quantification value as an explanatory variable using a set of pairs of the service amount and the function rule quantification value acquired for each valid period of the function rule quantification value with respect to each node 31. Accordingly, the capability model generation unit 23 generates the service amount estimation equation. The service amount estimation equation is represented by, for example, a following equation (1).

$${μ}_{n 1} = \frac{A}{{rule}_{n 1}} + B \qquad ( 1 )$$

Here, ruleₙ₁ represents a function rule quantification value of a node n1, and μₙ₁ represents a service amount of the node n1. From the service amount estimation equation (1), a service amount can be estimated from a function rule quantification value of a certain node 31.

Further, the capability model generation unit 23 adopts a following equation (2) which is used in a multiple-channel queuing model (M/M/S) as a model representative of behavior of the node 31.

p=λ/Sμ (2)

Here, λ represents a traffic amount arriving at the node 31 (for example, megabytes per second: Mbps). The μ represents the service amount of the node 31 estimated by the above-described service amount estimation equation (1). The S represents the number of scales (the number of the node instances 32) as the number of parallel processing in the node 31. The p represents an operating rate representing a congestion degree (0 to 1) of processing in each node 31. As the operating rate ρ approaches 1, a queueing time becomes longer. A specified value is set to the operating rate ρ.

The capability model generation unit 23 generates the service amount estimation equation of the equation (1) and the equation (2) as the capability model. For example, the capability model generation unit 23 associates the equation (1), the equation (2), a value of the operating rate ρ, and the node ID and stores them in the capability model storage unit 230.

The chain instance generation unit 24 acquires the definition information of the service chain 43 and information of the amount of input traffic assumed to the service chain 43. The definition information of the service chain 43 includes each node 31 to be connected and the content of the function rule set to each node 31 as described above. The information of the assumed amount of input traffic may be, for example, a maximum amount of input traffic assumed in the processing by the service chain 43. The chain instance generation unit 24 estimates the amount of input traffic and the number of scales corresponding to the function rule quantification value using the capability model with respect to each node 31 included in the definition information of the service chain 43. Specifically, the chain instance generation unit 24 may calculate the number of scales with respect to each node 31 by applying the function rule quantification value acquired from the definition information and the acquired amount of input traffic to the equations (1) and (2) of the capability model.

The chain instance generation unit 24 generates chain instance information of the service chain 43 using the estimated number of scales and the definition information of the service chain 43. The chain instance information is information necessary for generating the chain instance. For example, the chain instance information may be information included in the definition information of the service chain 43 and also information including the number of scales of each of the included nodes 31. The chain instance generation unit 24 outputs the generated chain instance information to the control apparatus 80.

The control apparatus 80 generates an instance of the service chain 43 based on the chain instance information. Specifically, the control apparatus 80 may generate the node instances 32 of the set number of scales with respect to each node 31 included in the chain instance information according to the function rule on the service chain execution apparatus 40. If the chain instance indicated by the chain instance information already operates on the service chain execution apparatus 40, the control apparatus 80 may adjust the number of scales of each node 31 to the number of scales included in the chain instance information.

Operations of the number-of-scales management system 2 as configured above are described with reference to the attached drawings.

The operations that the acquisition apparatus 50 acquires the function rule setting history and the service history from the service chain execution apparatus 40 are similar to the history acquisition operation in the first example embodiment of the present invention described with reference to FIG. 3. However, the information including the node ID, the setting content of the function rule, and the time stamp is acquired as the function rule setting history as described above in the present example embodiment. Further, the information including the node ID, the start time and the end time of the processing, and the data amount is acquired as the service history.

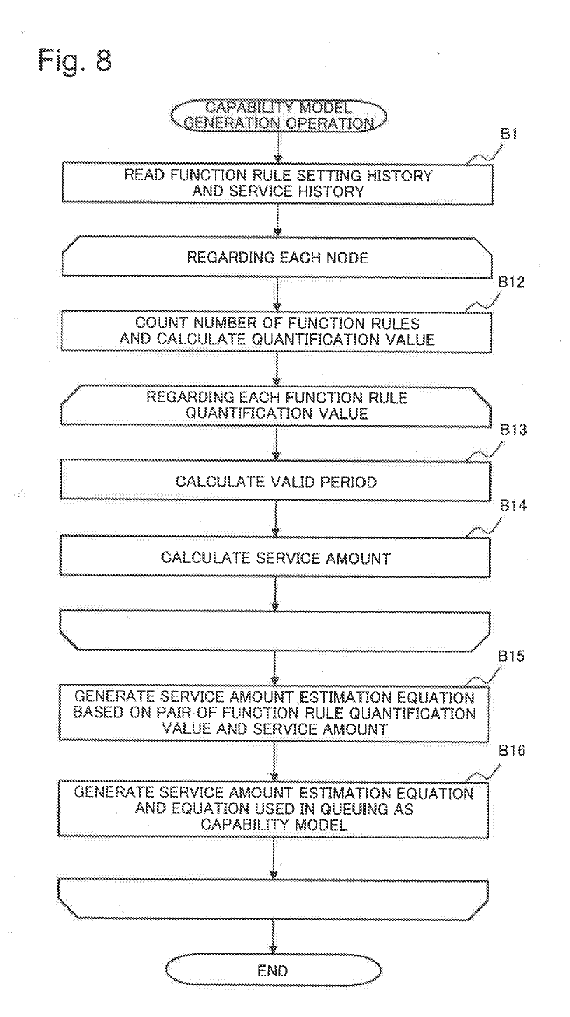

Next, the service model generation operation by the number-of-scales estimation apparatus 20 is illustrated in FIG. 8.

In FIG. 8, first, the function rule quantification unit 21 executes step B1 similarly to the first example embodiment of the present invention and reads the function rule setting history and the service history.

Next, the function rule quantification unit 21 repeats following steps B12 to B14 for each node 31 stored in the function rule setting history.

First, the function rule quantification unit 21 counts the number of function rules of each setting information included in the function rule setting history regarding the node 31 and regards the counted number as the function rule quantification value. Subsequently, the function rule quantification unit 21 associates the node ID of the node 31, the calculated function rule quantification value, and the time stamp included in the relevant setting information (step B12).

Next, the service amount calculation unit 22 repeats the following steps B13 and B14 for each function rule quantification value of the node 31 obtained in step B12.

First, the service amount calculation unit 22 calculates the valid period of the function rule quantification value (step B13).

As described above, the service amount calculation unit 22 may calculate a period from the time stamp of the setting information corresponding to the function rule quantification value to the time stamp of the next latest setting information of the node 31 as the valid period.

Next, the service amount calculation unit 22 calculates a value by dividing the average value of the data amount of each processing by the average value of the service time as the service amount with respect to the service history of the calculated valid period. Subsequently, the service amount calculation unit 22 associates the function rule quantification value, the calculated service amount, and the node ID (step B14).

When the processing of steps B13 and B14 is completed for each function rule quantification value calculated with respect to the node 31, next, the capability model generation unit 23 generates the capability model for the node 31.

Specifically, the capability model generation unit 23 first generates the service amount estimation equation (1) using a set of pairs of the acquired function rule quantification value and the service amount (step B15).

As described above, the capability model generation unit 23 may determine A and B in the above described service amount estimation equation (1) by performing statistical analysis using the service amount as the objective variable and the rule amount as the explanatory variable.

Next, the capability model generation unit 23 generates the capability model including the service amount estimation equation (1) generated in step B15 and the equation (2) used in the multiple-channel queuing model (M/M/S) (step B16).

Specifically, the capability model generation unit 23 may associate the service amount estimation equation (1), the equation (2) used in the multiple-channel queuing model (M/M/S), and the specified value of the operating rate p with the node ID of the node 31 and store them in the capability model storage unit 230.

Thus, the number-of-scales management system 2 terminates the capability model generation operation.

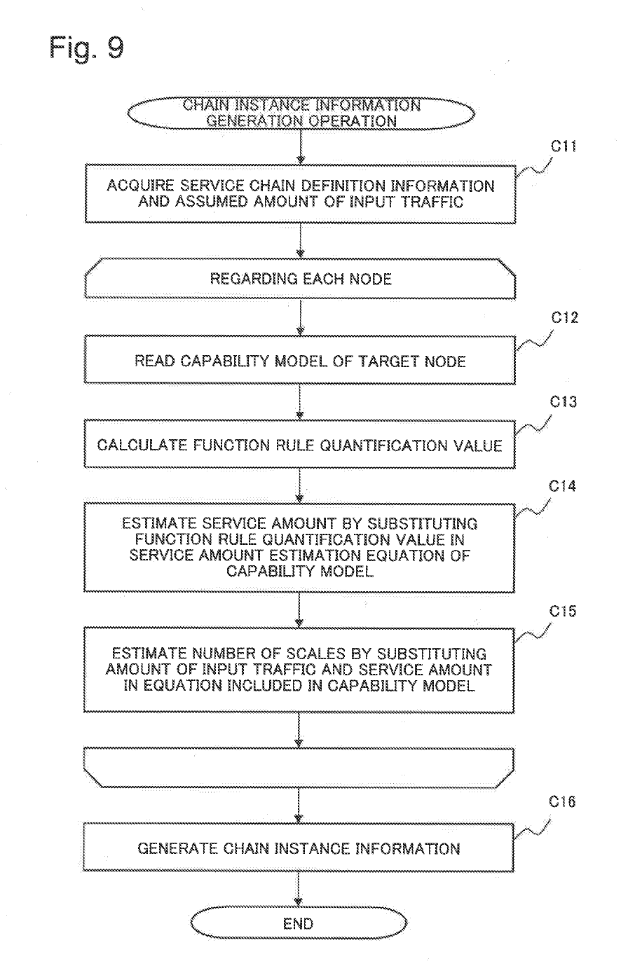

Next, a chain instance information generation operation of the number-of-scales management system 2 is illustrated in FIG. 9.

In FIG. 9, first, the chain instance generation unit 24 acquires the definition information of the service chain 43 and the amount of input traffic assumed to flow into the service chain 43 (step C11). For example, the chain instance generation unit 24 may acquire the definition information and the amount of input traffic from an input apparatus (not illustrated), the network interface 1005, the storage apparatus 1004, or the like.

As described above, the definition information of the service chain 43 includes the node ID of the nodes 31 to be connected in each service chain 43 and the function rule set to each node 31. As the assumed amount of input traffic, the maximum amount of input traffic which is assumed to be processed by each service chain 43 may be acquired.

Next, the chain instance generation unit 24 repeats operations in following steps C12 to C15 based on the definition information of the service chain 43 with respect to each node 31 as a component thereof.

First, the chain instance generation unit 24 reads the capability model of the node 31 from the capability model storage unit 230 (step C12).

Next, the chain instance generation unit 24 calculates the function rule quantification value from the function rule of the node 31 included in the service chain definition information using the function rule quantification unit 21 (step C13).

Next, the chain instance generation unit 24 substitutes the function rule quantification value calculated in step C13 in the service amount estimation equation (1) of the capability model of the node 31. Accordingly, the chain instance generation unit 24 calculates the service amount (step C14).

Next, the chain instance generation unit 24 substitutes the service amount calculated in step C14 and the amount of input traffic acquired in step C11 in the equation (2) included in the capability model of the node 31. Accordingly, the chain instance generation unit 24 calculates the number of scales which can satisfy the operating rate p (step C15).

When the processing of steps C12 to C15 is completed for each node 31 configuring the service chain 43, the chain instance generation unit 24 generates and outputs the chain instance information to the control apparatus 80 (step C16).

As described above, the chain instance information represents information for generating the instance of the service chain 43. The chain instance generation unit 24 may generate the chain instance information based on the definition information of the service chain 43 and the number of scales estimated for each node 31.

Thus, the number-of-scales estimation apparatus 20 terminates the chain instance generation operation.

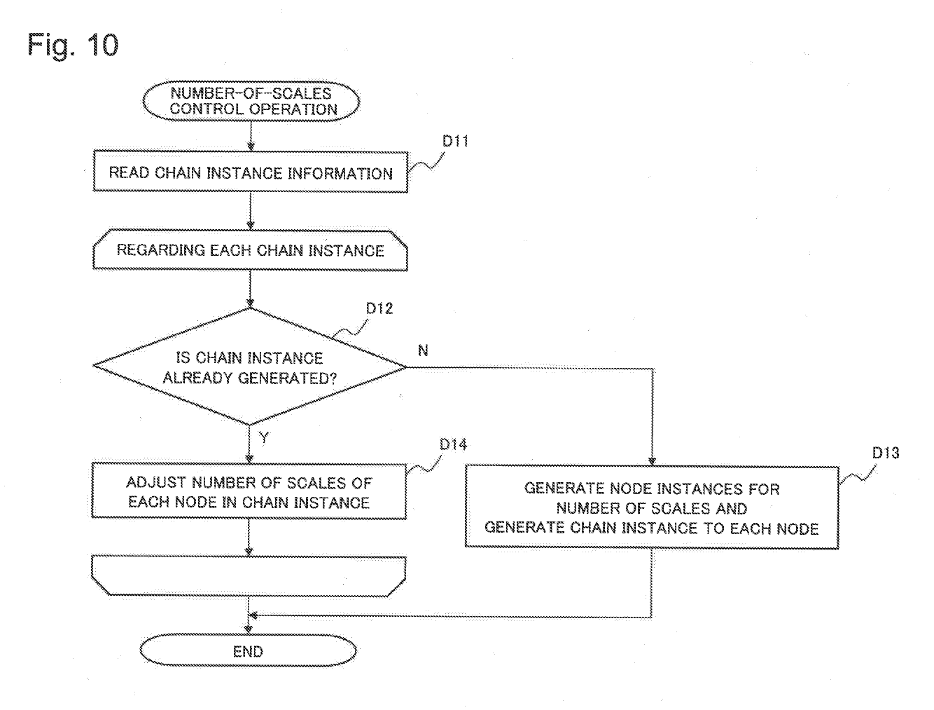

Next, the number-of-scales control operation of the control apparatus 80 is illustrated in FIG. 10.

In FIG. 10, first, the control apparatus 80 acquires the chain instance information from the number-of-scales estimation apparatus 20 (step D11).

Next, the control apparatus 80 repeats following steps D12 to D14 for each chain instance included in the acquired chain instance information.

First, when the relevant chain instance is not yet generated (NO in step D12), the control apparatus 80 generates the chain instance on the service chain execution apparatus 40. Specifically, the control apparatus 80 generates the node instances 32 of each node 31 configuring the chain instance by the number of scales (step D13).

On the other hand, when the relevant chain instance already operates (YES in step D12), the control apparatus 80 changes the number of the node instances 32 so as to be the number of scales with respect to each node 31 included in the relevant chain instance (step D14).

Thus, the number-of-scales management system 2 terminates the number-of-scales control operation.

Next, the operations of the number-of-scales management system 2 are described in a specific example. In the specific example, it is assumed that several service chains 43 already operate in the service chain execution apparatus 40. Further, the node ID for identifying each node 31 is referred to as “nodeX”, and the node 31 of which the node ID is nodeX may be simply referred to as “nodeX”.

### <Acquisition Operation of Function Rule Setting History and Service History>

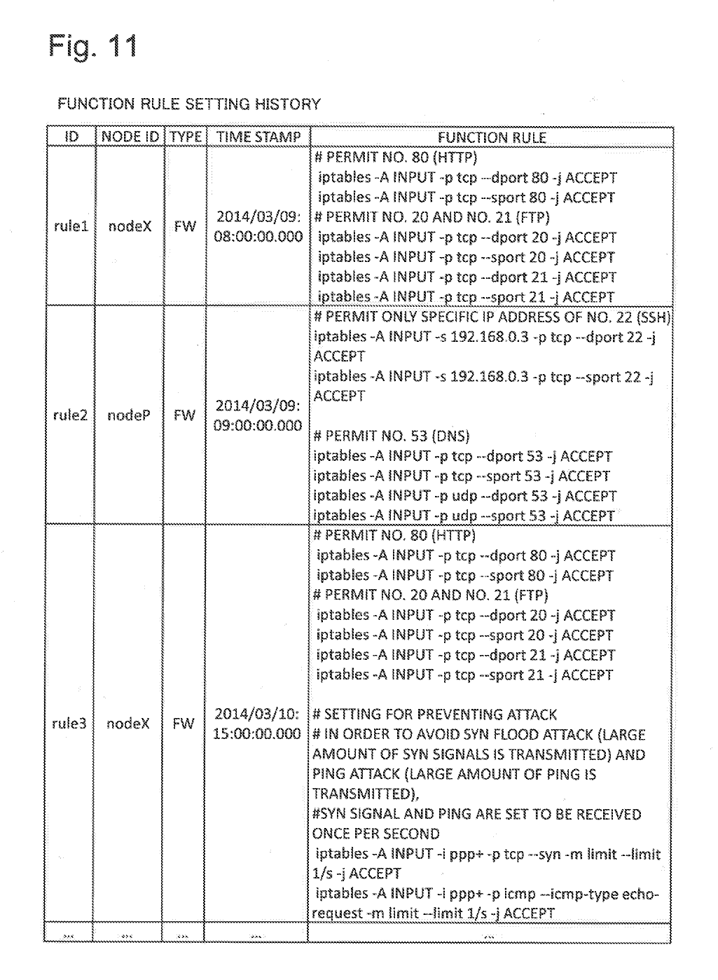

First, the acquisition apparatus 50 acquires the function rule setting history of each node 31 in the service chain 43 from the service chain execution apparatus 40 and stores the function rule setting history in the function rule setting history storage unit 501 (step A1). The acquired function rule setting history includes the node ID, the setting content of the function rule, and the time stamp. Here, it is assumed that the function rule setting history illustrated in FIG. 11 is acquired. In FIG. 11, for example in the case of nodeP, two function rules related to SSH (Secure SHell) and four function rules related to DNS (Domain Name System), i.e., six function rules in total are set at the time stamp “2014/03/09: 09:00:00.000”. The function rule setting history illustrated in FIG. 11 includes information representing a type of the function of the node 31 in each setting information, however, the function rule setting history in the present example embodiment may include at least the node ID, the setting content of the function rule, and the time stamp.

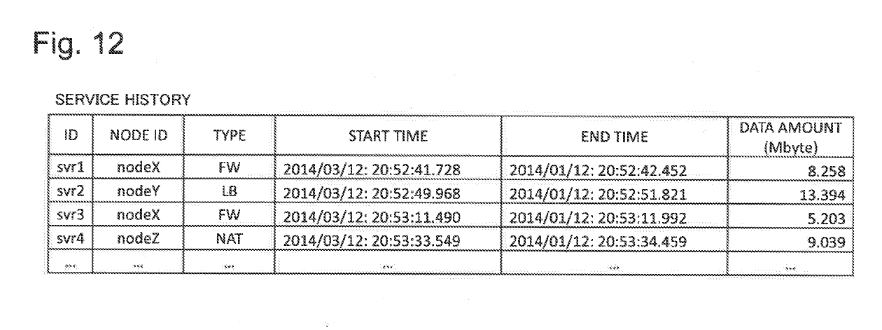

Next, the acquisition apparatus 50 acquires the service history of each node 31 in the service chain 43 from the service chain execution apparatus 40 and stores the service history in the service history storage unit 502 (step A2). The acquired service history includes the node ID, the start time and the end time of the processing, and the processed data amount. Here, it is assumed that the service history illustrated in FIG. 12 is acquired. The service history illustrated in FIG. 12 includes information representing the type of the function of the node 31 in each processing history, however, the service history in the present example embodiment may include at least the node ID, the start time and the end time of the processing, and the data amount.

Thus, the acquisition apparatus 50 repeats the processing of steps A1 and A2 during a certain period and accumulates the function rule setting histories and the service histories.

### <Capability Model Generation Operation>

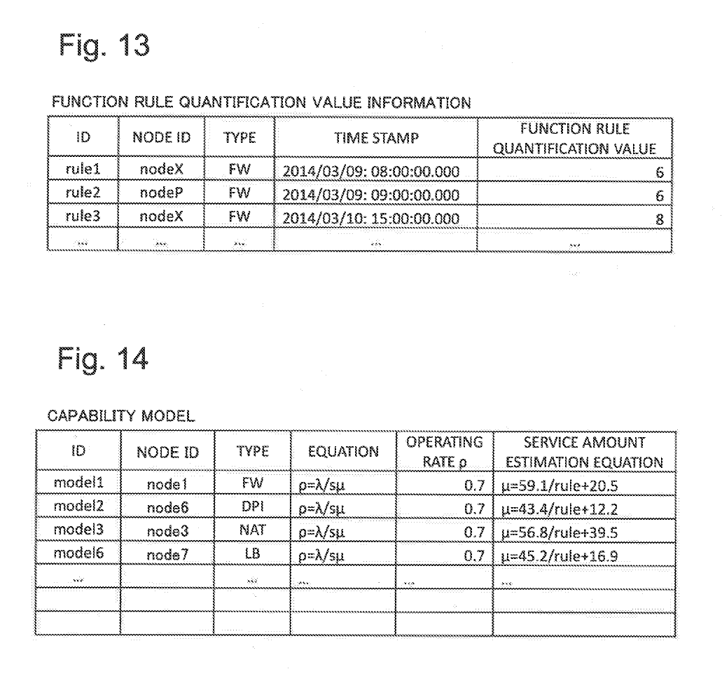

Next, the capability model generation unit 23 counts the number of function rules for each setting information of each node 31 from the information in FIG. 11 stored in the function rule setting history storage unit 501 and regards the counted number as the function rule quantification value. Further, the capability model generation unit 23 associates the node ID, the function rule quantification value, and the time stamp (step B12). Accordingly, the function rule quantification value information illustrated in FIG. 13 is generated. The function rule quantification value information illustrated in FIG. 13 includes information representing the type of the function of the node 31, however, the function rule quantification value information in the present example embodiment may include at least the node ID, the function rule quantification value, and the time stamp.

Next, the service amount calculation unit 22 calculates the valid period from when the function rule comes into effect to when the function rule is updated with respect to each function rule quantification value based on the function rule quantification value information (step B13). Subsequently, the service amount calculation unit 22 calculates the service amount of the node 31 for each valid period of the function rule quantification value (step B14).

For example, in the function rule quantification value information in FIG. 13, in the case of nodeX, six function rules are set to the time stamp t1 “2014/03/09: 08:00:00.000” and then the function rules are updated to eight function rules at the time stamp t2 “2014/03/10: 15:00:00.000”. Thus, a period from t1 to t2 is the valid period for the function rule quantification value (the number of rules is six) of nodeX.

The service amount calculation unit 22 acquires the service history of nodeX in the period from t1 to t2 from the service history in FIG. 12. Further, a service amount μ representing a processing capability is calculated by dividing the average value of the data amount by an average value of difference between the start time and the end time (the service time) of each history. For example, when a unit of the data amount is Mb (megabyte), and a unit of the service time is “s” (second), a unit of the service amount is “Mbps (megabytes per second)”.

The service amount calculation unit 22 repeats the above-described processing for each setting information of each node 31 to generate a set of pairs of the function rule quantification value and a value of the service amount with respect to each node 31.

Next, the capability model generation unit 23 calculates constants A and B in the service amount estimation equation indicated in the equation (1) by performing statistical analysis on each node 31 using the service amount as the objective variable and the rule amount as the explanatory variable. For example, it is assumed that the service amount estimation equation representing

μ=59.1/rule+20.5″ (1′)

is acquired with respect to nodeX. The service amount estimation equation (1′) represents that the service amount decreases as the function rule quantification value (the number of rules) increases (step B15).

The capability model generation unit 23 stores the acquired service amount estimation equation (1), the equation (2) used in the multiple-channel queuing model, and the operating rate ρ (0.7 here) in the capability model storage unit 230 as the capability model for each node 31 (step B16). Here, it is assumed that, for example, the capability model illustrated in FIG. 14 is stored in the capability model storage unit 230. The capability model illustrated in FIG. 14 includes information representing the type of the function of the node 31, however, the capability model of the present example embodiment may include at least the node ID, the service amount estimation equation, the equation representative of the relationship among the service amount, the amount of input traffic, and the number of scales, and the value of the operating rate.

### <Chain Instance Generation Operation>

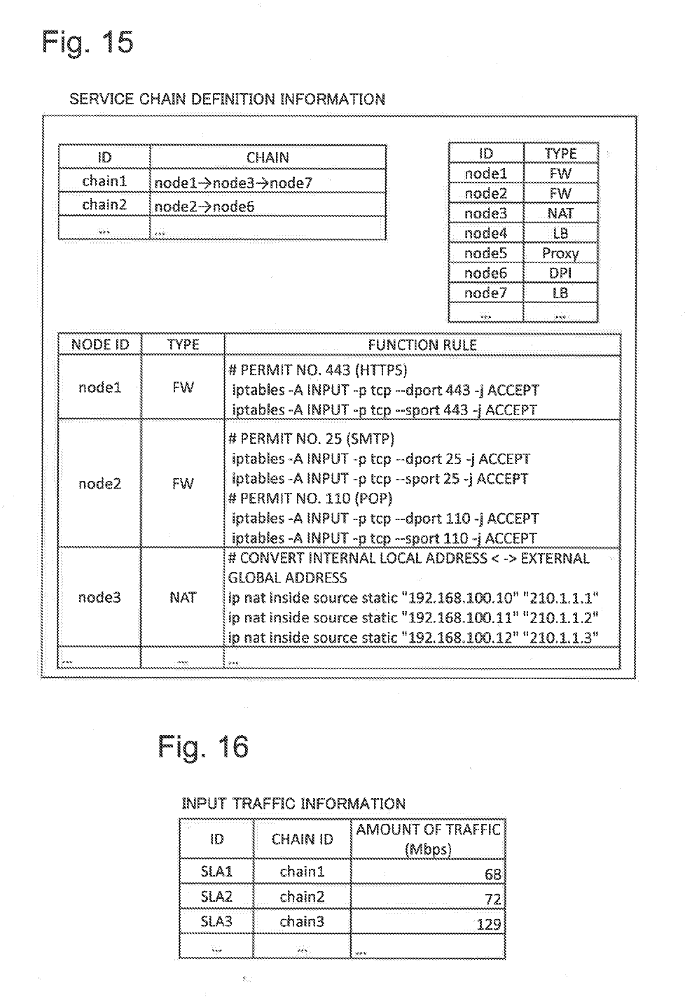

Next, the chain instance generation unit 24 acquires the service chain definition information illustrated in FIG. 15 as the definition information regarding the service chain 43 generated on the service chain execution apparatus 40. In FIG. 15, the service chain 43 identified by an ID of chain1 connects node1 functioning as FW, node3 functioning as NAT, and node7 functioning as LB and make them function. Further, the service chain 43 identified by an ID of chain2 connects node2 functioning as FW and node6 functioning DPI (Deep Packet Inspection) and make them function. As illustrated in FIG. 15, the service chain definition information includes the node ID configuring the service chain 43 and the setting content of the function rule of each node 31.

The chain instance generation unit 24 acquires information of the maximum amount of input traffic assumed to each service chain 43 included in the service chain definition information illustrated in FIG. 15. For example, the acquired information is as illustrated in FIG. 16 (step C11).

Next, the chain instance generation unit 24 reads the capability model of each node 31 as the component of each service chain 43 included in the definition information from the information illustrated in FIG. 14 stored in the capability model storage unit 230 (step C12).

Next, the chain instance generation unit 24 quantifies the function rule set with the definition information using the function rule quantification unit 21 with respect to each node 31 as the component of each service chain 43. For example, in the service chain definition information in FIG. 15, two function rules are set to node1. Thus, the function rule quantification value of node1 is “2” (step C13).

Next, the chain instance generation unit 24 substitutes the function rule quantification value of the node 31 acquired from the definition information in the service amount estimation equation (1) included in the capability model of the node 31. For example, in FIG. 14, the capability model of node1 includes the service amount estimation equation (1′) “μ=59.1/rule+20.5”. Thus, the chain instance generation unit 24 substitutes the function rule quantification value “rule=2” in the equation (1′) to estimate the service amount as “μ=50.05” (step C14).

Next, the chain instance generation unit 24 refers to information of the amount of input traffic illustrated in FIG. 16 and calculates a value “λ=68 (Mbps)” of the amount of input traffic assumed to the chain instance “chain1” including node1. Subsequently, the chain instance generation unit 24 substitutes “λ=68 (Mbps)” and “μ=50.05” calculated from the service amount estimation equation (1′) in the equation (2) ρ=λ/Sμ. Accordingly, the chain instance generation unit 24 calculates the number of scales “2” which can satisfy the operating rate 0.7 (step C15).

The chain instance generation unit 24 thus executes the processing of steps C12 to C15 on each node 31.

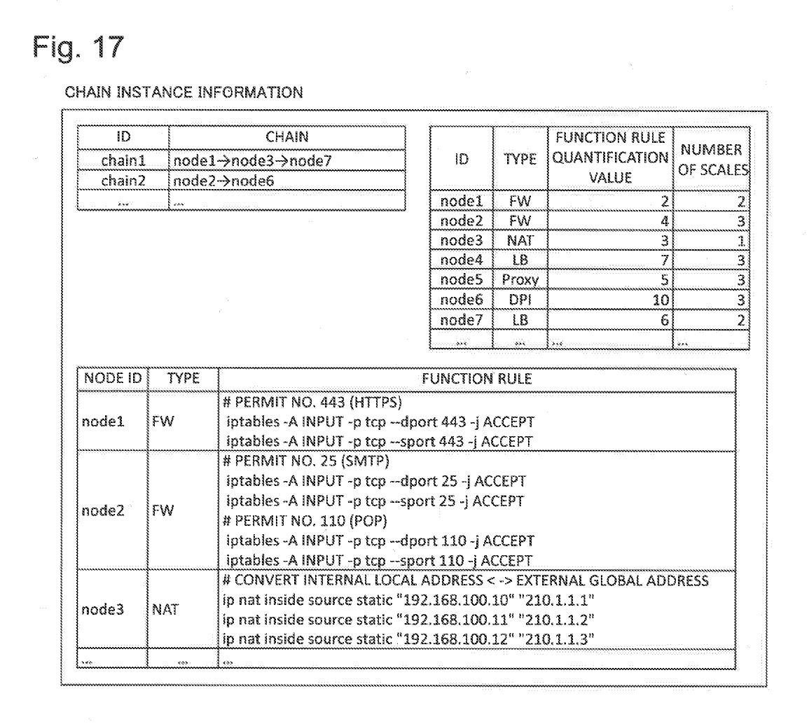

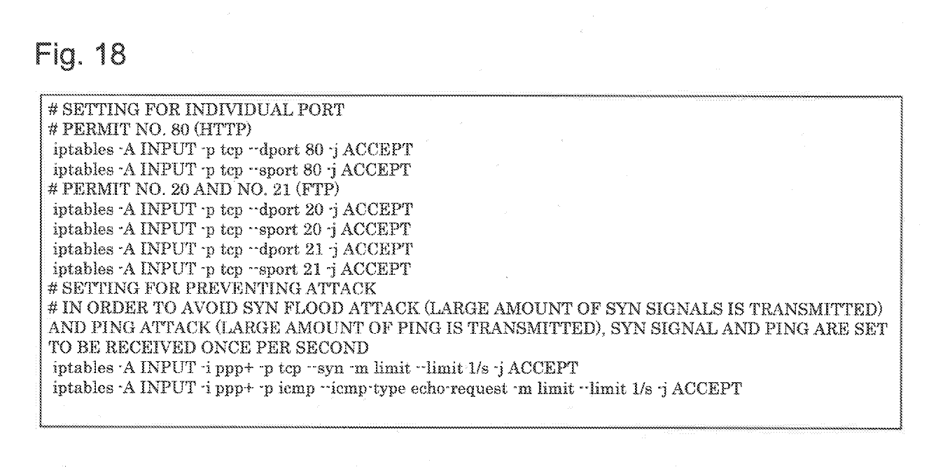

Subsequently, the chain instance generation unit 24 generates the chain instance information as illustrated in FIG. 17 using the estimated number of scales of each node 31 and the service chain definition information in FIG. 15 (step C16). The chain instance information illustrated in FIG. 17 includes the function rule quantification value of each node 31 but does not always need to include it. The chain instance information of the present example embodiment may at least include the number of scales of each node 31 configuring each chain instance in addition to the definition information of the service chain.

### <Number-of-Scales Control Operation>

Next, the control apparatus 80 reads the chain instance information in FIG. 17 (step D11) and generates the chain instance on the service chain execution apparatus 40. Specifically, the control apparatus 80 generates and operates the node instances 32 of the specified number of scales for each node 31 of each service chain 43. Alternatively, the control apparatus 80 adjusts the number of the node instances 32 of each node 31 to be the number of scales included in the chain instance information with respect to the service chain 43 which is already operating (steps D12 to D14).

Thus, the description of the specific operations of the number-of-scales management system 2 is terminated.

Next, an effect of the second example embodiment of the present invention is described.

The number-of-scales management system as the second example embodiment of the present invention can more precisely estimate the capability of processing the instances in the node of the service chain execution apparatus and more precisely control the number of scales that can deal with then input traffic.

The reason of the effect is described. In the present example embodiment, the acquisition apparatus acquires the function rule setting history and the service history of each node of the service chain. The function rule quantification unit of the number-of-scales estimation apparatus calculates the function rule quantification value based on the number of function rules of each node configuring the service chain. The service amount calculation unit calculates the service amount per unit time of the node instance by dividing the average value of the processed data amount by the average value of the service time in each node. The capability model generation unit performs statistical analysis on the set of pairs of the function rule quantification value and the service amount to generate the number-of-scales estimation equation for estimating the number of scales from the function rule quantification value. The capability model generation unit generates the capability model including the number-of-scales estimation equation and the equation representative of the relationship among the service amount, the amount of input traffic, and the number of scales. The number-of-scales estimation unit estimates the number of scales corresponding to the amount of input traffic assumed to flow into the service chain and the assumed function rule using the capability model. Subsequently, the control apparatus generates the service chain so that the number of node instances becomes the one based on the estimated number of scales, and thus the effect of the second example embodiment is acquired.

Accordingly, the present example embodiment can improve the estimation precision of the capability of processing the node instances in response to the content of the function rule set to each node in the service chain and a change thereof. Accordingly, the present example embodiment can more precisely estimate the number of scales which can process the input traffic assumed to flow into the service chain with the necessary minimum resources.

In the second example embodiment of the present invention, the example is mainly described in which the function rule quantification unit calculates the function rule quantification value based on the number of function rules. In addition, the function rule quantification unit may calculate pieces of information which can quantify and express the setting content of the function rule and a value based on a combination of such pieces of information as the function rule quantification value.

Further, in the second example embodiment of the present invention, the example is mainly described in which the service amount calculation unit calculates the service amount from the average value of the service time and the average value of the data amount of the node instance in each node. In addition, as the service amount, the service amount per unit time of the node instance in each node may be calculated by another calculation method using the service history of each node.

Further, in the second example embodiment of the present invention, the example is mainly described in which the capability model is configured by the service amount estimation equation and the equation used in the queuing model. In addition, the capability model may be another model as long as the model can estimate the number of scales from the function rule quantification value and the amount of input traffic.

In each of the above-described example embodiments of the present invention, the example is mainly described in which each function block of each apparatus configuring the number-of-scales management system is realized by the CPU executing the computer program stored in the storage apparatus or the ROM. In addition, a part, a whole, or a combination of each function block of each apparatus may be realized by dedicated hardware.

In each of the above-described example embodiments of the present invention, the function block of each apparatus configuring the number-of-scales management system may be realized by being distributed to a plurality of apparatuses. Further, as described above, each apparatus may be partially or entirely realized on the same apparatus.

In each of the above-described example embodiments of the present invention, the operations of each of the apparatuses described with reference to the respective flowcharts may be stored in the storage apparatus (storage medium) of the computer as the computer programs of the present invention. The CPU may read and execute the computer programs. In such a case, the present invention is configured by a code of the computer program or the storage medium.

Each of the above-described example embodiments may be implemented by being appropriately combined.

Thus, the present invention has been described using the above-described example embodiments as exemplary examples. However, the present invention is not limited to the above-described example embodiments. In other words, various aspects which can be understood by those skilled in the art can be applied to the present invention within the scope of the present invention.

This application is based upon and claims the benefit of priority from Japanese Patent Application No. 2014-182814 filed on Sep. 9, 2014, the entire disclosure of which is incorporated herein.

[Reference signs List]

| | |
|---|---|
| 1, 2 | Number-of-scales management system |
| 10, 20 | Number-of-scales estimation apparatus |
| 30 | Network function providing apparatus |
| 40 | Service chain execution apparatus |
| 50 | Acquisition apparatus |
| 70, 80 | Control apparatus |
| 11, 21 | Function rule quantification unit |
| 12, 22 | Service amount calculation unit |
| 13, 23 | Capability model generation unit |
| 14 | Number-of-scales estimation unit |
| 24 | Chain instance generation unit |
| 31 | Node |
| 32 | Node instance |
| 43 | Service chain |
| 130, 230 | Capability model storage unit |
| 501 | Function rule setting history storage unit |
| 502 | Service history storage unit |
| 100, 300, 500, 700 | Computer apparatus |
| 1001, 3001, 5001, 7001 | CPU |
| 1002, 3002, 5002, 7002 | RAM |
| 1003, 3003, 5003, 7003 | ROM |
| 1004, 3004, 5004, 7004 | Storage apparatus |
| 1005, 3005, 5005, 7005 | Network interface |

1. A number-of-scales estimation apparatus comprising:
a memory storing instructions; and
one or more processors configured to execute the instructions to:
calculate a function rule quantification value obtained by quantifying a function rule based on a setting history of the function rule set to a node providing a network function;
calculate a service amount per unit time of a node instance operating in the node based on a service history of the node;
generate a capability model representative of a relationship among an amount of input traffic to the node, the function rule quantification value, and a number of the node instances (a number of scales) based on a pair of the function rule quantification value and the service amount acquired for the node; and
use the capability model to estimate the number of scales in accordance with the amount of input traffic to be assumed and the function rule quantification value.

2. The number-of-scales estimation apparatus according to claim 1, wherein the one or more processors are further configured to execute the instructions to:
estimate a service amount estimation equation for calculating the service amount from the function rule quantification value based on the pair of the function rule quantification value and the service amount acquired for the node, and generates the capability model including the estimated service amount estimation equation.

3. The number-of-scales estimation apparatus according to claim 2, wherein the one or more processors are further configured to execute the instructions to:
include an equation representative of a relationship among a service amount estimated by the service amount estimation equation, the amount of input traffic, and the number of scales in the capability model.

4. The number-of-scales estimation apparatus according to claim 1, wherein the one or more processors are further configured to execute the instructions to:
calculate the service amount for each valid period of the function rule quantification value.

5. The number-of-scales estimation apparatus according to claim 1, wherein the one or more processors are further configured to execute the instructions to:
calculate the function rule quantification value based on a number of function rules set to the node.

6. A number-of-scales management system comprising:
a network function providing apparatus comprising a node providing a network function;
an acquisition apparatus configured to acquire a setting history of a function rule (a function rule setting history) set to the node and a service history of the node from the network function providing apparatus;
the number-of-scales estimation apparatus according to claim 1 configured to use the function rule setting history and the service history acquired by the acquisition apparatus and estimate a number of scales of the node in the network function providing apparatus; and
a control apparatus configured to control the number of scales of the node in the network function providing apparatus based on the number of scales estimated by the number-of-scales estimation apparatus.

7. The number-of-scales management system according to claim 6, wherein, when the network function providing apparatus is configured by a service chain execution apparatus executing a service chain that connects a plurality of the nodes and causes the nodes to function,
one or more processors of the number-of-scales estimation apparatus configured to execute the instructions to:
estimate a number of scales of a node included in the service chain in accordance with an amount of input traffic assumed to flow into the service chain, and
the control apparatus controls the number of scales of the node in the service chain based on the number of scales estimated by the number-of-scales estimation apparatus.

8. A number-of-scales estimation method comprising:
calculating a function rule quantification value obtained by quantifying a function rule based on a setting history of the function rule set to a node providing a network function;
calculating a service amount per unit time of a node instance operating in the node based on a service history of the node;
generating a capability model representative of a relationship among an amount of input traffic to the node, the function rule quantification value, and a number of the node instances (a number of scales) based on a pair of the function rule quantification value and the service amount acquired for the node; and
using the capability model to estimate the number of scales in accordance with the amount of input traffic to be assumed and the function rule quantification value.

9. A number-of-scales management method comprising:
acquiring a setting history of a function rule (a function rule setting history) set in a node in a network function providing apparatus including the node providing a network function;
acquiring a service history of the node in the network function providing apparatus;
estimating a number of scales of the node in the network function providing apparatus using the number-of-scales estimation method according to claim 8 based on the acquired function rule setting history and the service history; and
controlling the number of scales of the node in the network function providing apparatus based on the estimated number of scales.

10. A non-transitory computer readable storage medium storing a computer program that causes a computer to execute:
a process of calculating a function rule quantification value obtained by quantifying a function rule based on a setting history of the function rule set to a node providing a network function;
a process of calculating a service amount per unit time of a node instance operating in the node based on a service history of the node;
a process of generating a capability model representative of a relationship among an amount of input traffic to the node, the function rule quantification value, and a number of the node instances (a number of scales) based on a pair of the function rule quantification value and the service amount acquired for the node; and
a process of using the capability model to estimate the number of scales in accordance with the amount of input traffic to be assumed and the function rule quantification value.

11. The number-of-scales estimation apparatus according to claim 2, wherein the one or more processors are further configured to execute the instructions to calculate the service amount for each valid period of the function rule quantification value.

12. The number-of-scales estimation apparatus according to claim 3, wherein the one or more processors are further configured to execute the instructions to calculate the service amount for each valid period of the function rule quantification value.

13. The number-of-scales estimation apparatus according to claim 2, wherein the one or more processors are further configured to execute the instructions to calculate the function rule quantification value based on a number of function rules set to the node.

14. The number-of-scales estimation apparatus according to claim 3, wherein the one or more processors are further configured to execute the instructions to calculate the function rule quantification value based on a number of function rules set to the node.

15. The number-of-scales estimation apparatus according to claim 4, wherein the one or more processors are further configured to execute the instructions to calculate the function rule quantification value based on a number of function rules set to the node.
